(19) United States
(12) Patent Application Publication
(10) Pub. No.: US 2016/0021705 A1
(43) Pub. Date: Jan. 21, 2016

(54) SELF-REGULATING CONDUCTIVE HEATER AND METHOD OF MAKING

(71) Applicant: Gentherm Canada Ltd., Windsor (CA)

(72) Inventors: Jack Barfuss, Windsor (CA); Syed Rafat Iqbal, LaSalle (CA)

(21) Appl. No.: 14/333,975

(22) Filed: Jul. 17, 2014

(51) Int. Cl. H05B 3/14; H01C 17/02; H01C 17/28; H05B 3/18

(52) U.S. Cl. CPC H05B 3/145; H05B 3/18; H01C 17/02; H01C 17/28

(57) ABSTRACT

A heater comprising: a heater layer including: (a) a thermoplastic elastomer; and (b) a plurality of conductive fillers mixed within the thermoplastic elastomer, wherein the conductive fillers are a metal coated material or entirely made of metal; and wherein the heater layer is made up of about 30 percent or less conductive fillers.

### FIELD

The present teachings generally relate to an improved heating device and more specifically a self-regulating heater that has a high degree of flexibility.

### BACKGROUND

The present teachings are predicated upon providing an improved heater and more preferably an improved heater for use in a vehicle. Generally, heaters include a wire that is formed in a pattern. The wire produces heat when electricity is applied to the wire. The wire may also be placed in a carbonaceous material so that as the wire heats up the heat is diffused into the carbonaceous material heating a larger area. However, achieving uniform heating in these devices may not always be achieved and hot spots may occur around the heating wires. Further, if a heating wire breaks the heater may cease to heat. Heaters may also include electrodes that are connected by a positive temperature coefficient material so that electricity is conducted from one electrode through the positive coefficient material to the other electrode and heat is produced. Other heaters have a woven configuration where a plurality of long materials are woven together to form a heater. These heaters may result in hot spots along one or more of the long materials as these materials may allow for current drift along one wire. Examples of heaters may be found in U.S. Pat. Nos. 6,057,530; 6,172,344; 6,294,758; 7,053,344; and 7,285,748; U.S. Patent Application Publication Nos. 2003/0155347; 2012/0013433; and 2013/0186884; European Patent No. EP2400814 and EP 0490989 all of which are incorporated by reference herein for all purposes.

Despite many of these heaters being commercially available, it would be attractive to have a heater with a high degree of flexibility to conform to an occupant and to avoid crinkling noises or the like in response to occupant motion. It would be attractive to have a heater with an entire heating layer that exhibits self-regulating characteristics. It would be attractive to minimize part quantities in an assembly and correspondingly to reduce assembly steps. Notwithstanding what exists today, car manufacturers and others continue to seek low cost, light weight, and easy to manufacture ways to provide a heating surface. It would be attractive to avoid dependency of adhesive bonding of conductive metals to a surface. Further, it would be attractive to reduce and/or remove precious metals from the heaters.

It would be attractive to have a heater that is free of extensions or fingers extending from the bus bars to provide heating. It would be attractive to have a heater that exhibits uniform heating across the heater without haying to employ complex power supply configurations and/or expensive controllers. What is further needed is a flexible seat heater that is substantially impervious to fluids, current leakage, or both without additional protective materials that are fluid impenetrable.

### SUMMARY

The present teachings meet one or more not all) of the present needs by providing: a heater comprising: a heater layer including: (a) a thermoplastic elastomer; and (b) a plurality of conductive fillers mixed within the thermoplastic elastomer, wherein the conductive fillers are a metal coated material or entirely made of metal; and wherein the heater layer is made up of about 30 percent or less conductive filers.

The heater of the teachings may include: a method of producing a heater comprising: (a) mixing a thermoplastic elastomer together with a plurality of conductive fibers: (b) forming the mixture into a sheet; (c) cutting the sheet into one or more heating layers; wherein upon application of power the heating layer provides heat.

The teachings herein surprisingly solve one or more of these problems by providing a flexible seat heater that is free of and/or substantially free of gold, silver, and copper. The present teachings provide a heater with a high degree of flexibility to conform to an occupant and to avoid crinkling noises or the like in response to occupant motion. The present teachings provide a heater with an entire heating layer that exhibits self-regulating characteristics. The present teachings avoid dependency of adhesive bonding of conductive metals to a surface The present teachings reduce and/or remove precious metals from the heaters. The present teachings provide a heater that is free of extensions or fingers extending from the bus bars to provide heating. The present teachings provide a heater that exhibits uniform heating across the heater without having to employ complex power supply configurations and/or expensive controllers. The present teachings provide a flexible seat heater that is substantially impervious to fluids, current leakage, or both without additional protective materials that are fluid impenetrable.

### BRIEF DESCRIPTION OF THE DRAWINGS

FIG. 1 illustrates one example of a system to produce a heater taught herein;

FIG. 2 illustrates an example of applying power application portions to the heating layer;

FIG. 3 illustrates an example of applying protective layers to the heating layer;

FIG. 4 illustrates a power application portions connected to the heater layer;

FIG. 5 illustrates sectioning the series of connected heater portions;

FIG. 6 illustrates one example of a heater taught herein;

FIG. 7 illustrates another example of a heater taught herein;

FIG. 8 illustrates a cross-sectional view of the heater of FIG. 7; and

FIG. 9 illustrates an example of a heating layer including thermoplastic elastomer including conductive fillers.

### DETAILED DESCRIPTION

The explanations and illustrations presented herein are intended to acquaint others skilled in the art with the invention, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The device as taught herein may be useful as a heater and/or incorporated into another device so that the other device may be used as a heater. The device as taught herein may be used for heating. For example, the heater may be used to heat a bed, plants, be a therapeutic heater, vehicle seats, steering wheels, mirrors, glass, flooring, arm rests, regions of a vehicle that an occupant contacts, internal upholstery, clothing, dashboard, ceiling, under a liner, under carpet, on a floor, the like, or a combination thereof. Preferably, the device as taught herein may be connected to, incorporated into, or both a vehicle seat and/or the vehicle seat may include the composition taught herein so that a vehicle seat may be heated. The heater as discussed herein may be a discrete piece that is laid over a cushion of a vehicle seat (i.e., bun or back portion) and then a trim cover placed over the heater. The heater may be incorporated into the trim cover of the vehicle seat. A portion of the heater may enter a trench in the cushion so that the heater, the cushion, the trim cover, or a combination thereof are attached to a seat frame. The heater may be shapeable, formable, cuttable, or a combination thereof so that heater may be substantially prevented form heating the trench regions of a vehicle seat. For example, a portion of the heater may be cut out so that substantially only the electrodes, buses, power conductors, or a combination thereof extend into the trench of a vehicle seat. In another example, the heating layer may be cut so that the heating layer extends up to the trench in a central region of the heater but not into the trench and the portion of the heating layer proximate to the electrodes, buses, power conductors, or a combination thereof extends into and/or around the trench to provide support. A trim cover may have attachment features that extend through the heater so that the heater is connected to the trim cover and substantially extends over the trench while the attachment features act to secure both the trim cover and the heater to the seat.

The heater may be secured in the vehicle seat by a mechanical fastener, an adhesive, both. The heater may be secured directly to the trim layer, the cushion (i.e., bun, back, or both) of the seat, or a combination of both. A mechanical fastener may extend through, connect to, attach on, or a combination thereof the heater so that the heater may be fixed within the seat. The heater of the teachings herein may be used in conjunction with other devices.

The heater may be used with a passenger sensor. The heater may be placed over and/or under a passenger senor. The heater itself may be a passenger sensor. The passenger sensor may be any type of passenger sensor that senses the presence of a passenger, contact between a passenger and an internal component of a vehicle, a location of a passenger, or a combination thereof. The passenger sensor may be a capacitive sensor, a pressure sensor, a membrane sensor, infrared, passive and/or active ultrasonic sensor, a mass sensor, or a combination thereof. The heater and a passenger sensor may be used with an active cooling system, active heating system, a ventilated system, or a combination thereof.

The heater may be used with an active heating, active cooling, ventilation, or a combination thereof system. The heater may be porous so that air may pass directly through the heater (i.e., microscopic holes that extend through the heater and allow air to pass through the heater). The heater may include one or more porous layers that cover the heater so that air passes directly through the heater and the one or more layers that cover the heater (e.g., a fleece layer, an adhesive, a protective covering layer, or a combination thereof). The heater may include one or more protective layers that fully and/or partially cover the heater so that the barrier layers assist in directing fluid flow to regions of the heater that may be contacted. Preferably, the heater is substantially impervious to fluid flow through the heater (e.g., liquids or air). The heater may include one or more through holes so that air may be moved through the heater. The one or more through holes may have a pattern, may be random, may increase in cross-sectional area, decrease in cross sectional area, or a combination thereof. The heater may include and/or be in fluid communication with a fan and/or blower, be adjacent to a blower and/or fan so that the blower and/or fan may move a fluid through and/or around the heater, The heater, the fan, the blower, or a combination thereof may include a peltier device, a thermoelectric device, or both so that hot and/or cooled air (i.e., conditioned air) may be moved towards an occupant. The heater may be indirectly connected to a fan, blower, or both that include a peltier device, a thermoelectric device, or both. The heater may be connected to a fan, a blower, or both by an insert.

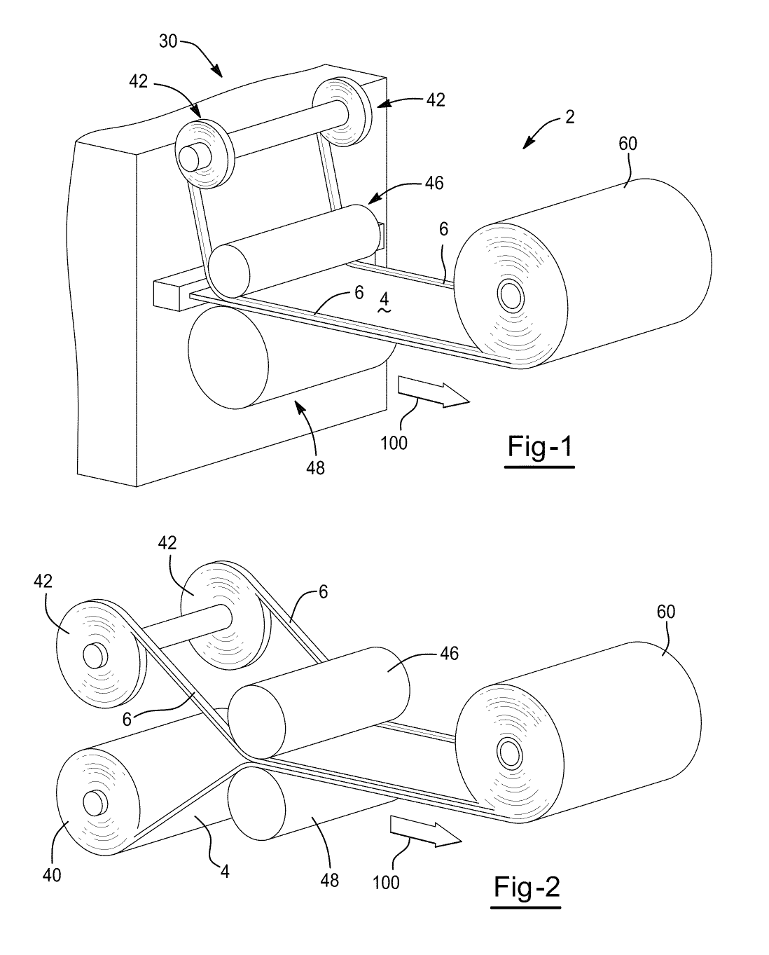

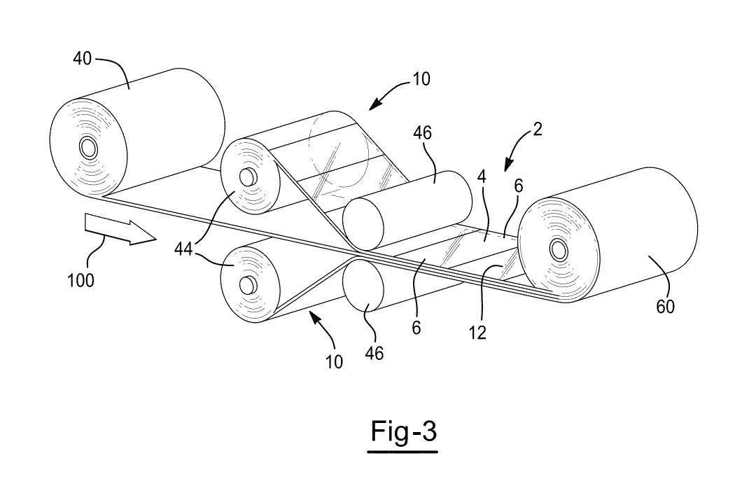

The heater may be connected to an insert (i.e., bag) that assists in distributing conditioned air to an occupant, The heater may be sealed to the insert around its periphery so that the heater forms an upper layer of the insert. The heater may be connected to an upper layer of an insert. The heater may have one or more holes that mirror the holes in the insert. The heater may have no holes and the air from the bag may pass directly through the heater in route to an occupant. The heater layer may be connected directly to the insert. All or a portion of the heater layer may be connected to the insert. The insert may be one or more polymeric layers that form a substantially air impermeable layer and/or an air impermeable layer so that air directed into the insert is directed to a predetermined region. The insert may include one or more spacer materials. Additional aspects of the insert and its various layers and materials can be gleaned from the teachings herein including those of Column 1, line 45 through Column 3, line 67; Column 4; line 54 though Column 6, line 32 and FIGS. 2-3 of Patent No. 7,083,227, and Column 3; line 34 through Column 10; line 2; Column 11, line 4 through Column 13, line 18; and FIGS. 1, 4, 15A and 15B of U.S. Pat. No. 7,735,932 incorporated by reference herein, which shows various alternative embodiments of inserts, insert materials, and insert constructions that may be used with the heater taught herein.

The heater may be formed as a sheet. The heater may include a heater layer that is a sheet. Preferably, the heater and/or heater layer as taught herein is a nonwoven sheet. The heating layer may include conductive fillers. For example, the heating layer as taught herein may be comprised of a plurality of individual conductive fillers (e.g., fibers) that optionally may be cut to a predetermined length and randomly oriented within a plastic, thermoplastic, thermoplastic elastomer, or a combination thereof to form the heater layer that produces heat when power is applied. The heater may conform to virtually any shape, be cut to virtually any shape, be formed into virtually any shape, or a combination thereof. For example, the heater may be wrapped around a circular object so that the circular object is heated. The heater may include a plurality of conductive fillers (e.g., fibers) that are combined with a polymer, preferably a thermoplastic, and more preferably a thermoplastic elastomer to form a heating layer. The heater layer may include a sufficient amount of conductive fillers so that the heater generates heat. The heater layer may include a sufficient amount of conductive fillers so that power travels from one power application portion in a first edge region through the heater layer and to a second power application portion in a second edge region. The heater lay may include a sufficient amount of conductive fillers so that the heating layer produces heat. The heater layer may include a sufficient amount of conductive fillers so that the resistivity of the plastic, thermoplastic, thermoplastic elastomer, or a combination thereof produces heat when power is applied. The heater layer may include a sufficient amount of conductive fillers so that heat created by the heater layer is substantially uniform across the longitude and latitude of the heating layer. The conductive fillers may reduce the resistance of the thermoplastic elastomer (i.e., the heating layer is more conductive with the conductive fillers). The percentage of the conductive filler in the total weight of the heating layer may be a sufficient amount of conductive fillers so that the heating layer reaches a temperature of about 80° C. or more, about 90° C. or more, about 100° C. or more, or even about 110° C. or more. The percentage of the conductive filler in the total weight of the heating layer may be a sufficient amount so that the resistivity of the heating layer is from about 2Ω to about 10Ω, preferably from about 3Ω to about 9Ω, and more preferably from about 4Ω about 8Ω. The heating layer may include about 40 percent by weight or less, preferably about 35 percent by weight or less, more preferably about 30 percent by weight or less, or even more preferably about 25 percent by weight or less conductive fillers. The heating layer may include about 5 percent by weight or more, 10 percent by weight or more, about 15 percent by weight or more, about 18 percent by weight or more, or even about 20 percent by weight or more conductive fillers. The heating layer may include from about 30 percent by weight to about 5 percent by weight conductive fillers, preferably from about 25 percent by weight to about 10 percent by weight conductive fillers, and more preferably from about 20 percent by weight to about 15 percent by weight conductive fillers.

Preferably, the plurality of conductive fillers are randomly distributed throughout the heating layer. More preferably, the plurality of conductive fillers have an average length so that when combined the conductive fillers cannot be woven around each other. Even more preferably, the average conductive filler length and orientation of the conductive fillers produces a substantially constant heat gradient, a substantially constant heat density, or both across the heater when power is applied. The conductive filler may be sufficiently randomly oriented so that the orientation of the conductive fillers forces the power to move and spread throughout the heater proving substantially uniform heating, a uniform heat density, or both and the power is free of traveling along one specific line. In an example, the heating layer taught herein is substantially free of conductive filler orientation so that the heating layer does not have a machine direction, a cross direction, or both. The heating layer may be free of individual heating wires, heating threads, or both and the heating may occur through the randomly oriented conductive fillers and the thermoplastic elastomer. Randomly oriented as discussed herein means than about 60 of the conductive fillers or less, about 50 or less, preferably about 40 percent or less, more preferably about 30 percent or less, or even more preferably about 20 percent or less of the conductive fillers are oriented in the same direction. The conductive fillers may be oriented in one or more directions along their length. For example a first end may point in a first direction and the second end may point in a direction that is angled relative to the first end (e.g., about 45 degrees or more)

The average conductive filler length may be any length so that a nonwoven sheet is formed and the sheet has sufficient strength to be bent, folded, cut, conduct power, be pushed into a trench, stretched, or a combination thereof. The average conductive filler length may be any length so that the conductive fillers have sufficient surface area so that when power is applied, power passes through the conductive fillers and the heater produces a substantially even temperature gradient (i.e., the temperature when measured randomly across the heater is within about ±5° C. or less, about ±3° C. or less, or about ±2° C. or less). The average conductive filler length may be about 5 mm or less, about 4 mm or less, about 3 mm or less, about 2 mm or less, about 1 mm or less, about 0.75 mm or less, about 0.5 mm or less, or even about, 0.3 mm or less. The average conductive filler length may vary from about 10 mm to about 0.001 mm, preferably from about 7 mm to about 0.01 mm, more preferably from about 3 mm to about 0.1 mm.

The conductive filler may be one material. The conductive filler may be a pure metal fiber. The conductive filler may be made of an alloy. The conductive filler may be a metal coated with another metal. The conductive filler may include a base material made of carbon, graphene, a polymer, a solid metal, or a combination thereof. The base material may be coated one or more times. When the base material is coated more than once each of the coatings may be the same or a different material. For example, a base material may be coated with copper and then nickel so that the copper is prevented for corroding. The base material may be coated with a conductive material. Preferably, the base material is coated with metal (e.g., nickel). Preferably, the heating layer includes a plurality of conductive fillers made of carbon or a polymer, and the conductive fillers are coated with one or more layers of a metallic material. One or more coatings may be applied to the base material before a layer is formed. The base material of the conductive fillers may be coated with any material that conducts electricity. Metals that may be used to coat the carbon conductive fillers, the polymer conductive fillers, the base material, or a combination thereof are copper, silver, gold, nickel, nickel chromium, brass, aluminum, tungsten, zinc, lithium, platinum, tin, titanium, plating 4, or a combination thereof. In one preferred embodiment the plurality of conductive fillers include a carbon base material. In yet another preferred example, the conductive fillers may be made entirely of metal. An example of one conductive filler is sold under the name NiFiber available from conductive composites. Another example of a conductive filler is available from IntraMicron. The plurality of conductive fillers discussed herein may be located within a thermoplastic elastomer.

The thermoplastic elastomer may function to form a connection (e.g., electrical connection, physical connection, or both) between two or more adjacent conductive fillers, between two or more power application portions (e.g., bus bars), or both. The thermoplastic elastomer may function to exhibit self-regulating characteristics (e.g., positive temperature coefficient characteristics). The thermoplastic elastomer may be any material that once set may bend; flex; be cut; be punched; resist ripping; resist tearing; be heated without melting, be heated without running, be heated without significantly softening; assist in conducting power; be free of preventing the transfer of power; have self-regulating characteristics; be resistive; become hot when power is applied; stretch, or a combination thereof. The thermoplastic elastomer may function to have a high rate of expansion, a high level of thermal expansion, or both. The thermoplastic elastomer may have a high rate of expansion when heated, when power is applied, or both. The thermoplastic elastomer have a thermal expansion coefficient (CTE) of about 20×10⁻⁶/K or more, preferably about 50 10^{31 6}/K or more, more preferably about 100 10⁻⁶/K, even more preferably about 150 10⁻⁶/K or more, or even about 175 10⁻⁶/K or more. The thermoplastic elastomer may have a thermal expansion coefficient of about 500 10⁻⁶/K or less, about 300 10⁻⁶/K or less, or preferably about 250 10⁻⁶/K or less. The thermoplastic elastomer may be any material that may conduct power and may become hot when power is applied. The thermoplastic elastomer may be a polymer, a thermoplastic, or both. Preferably, the thermoplastic elastomer is any polymer that exhibits a high rate of expansion. More preferably, the thermoplastic elastomer is polyethylene, polypropylene, ethyl vinyl alcohol (EVA), ethylene ethyl acrylate (EEA), thermoplastic urethane (TPU), Nylon, Nylon 6, Nylon 6, 6, Nylon 12, polyimide, or a combination hereof. The thermoplastic elastomer may be used in a sufficient amount so that the plurality of conductive fillers are held together and a sheet is formed. The thermoplastic elastomer may be used in the heater in an amount of about 40 percent by weight or more, preferably about 50 percent by weight or more, more preferably about 60 percent by weight or more, more preferably about 65 percent by weight or more, or even more preferably about 70 percent by weight or more. The thermoplastic elastomer may be present in an amount of about 75 percent or more, 80 percent or more, or even about 85 percent or more. The elastomeric polymer may form a continuous sheet that includes the conductive filler. The elastomeric polymer may form a sheet that has contours, holes, cutouts, narrow regions, slits, or a combination thereof.

The heater layer may be free of holes. The heater layer may include holes. The holes may be any shape so that heat is created and the adjoining surface, person, item, device, or a combination thereof is heated, The holes may be round, oval, square, cross-like, long and thin, symmetrical, asymmetrical, geometric, non-geometric, or a combination thereof. The heater layer may include side cutouts. Preferably, the heater layer may be free of side cutouts. The microstructure of the heating layer may be free of pores, voids, or both. Voids and pores as discussed herein may be part of the microstructure (e.g., created by an air pocket during manufacturing) of the heating layer whereas through holes and cutouts are larger and are a space where, for example, material has been removed. The heating layer may have a sufficient amount of conductive fillers and/or material in the heating layer so that one or more other layers may be connected to the heating layer, a protecting layer can form a planar surface over the heating layer, or both. The heating layer may have a sufficient amount of conductive fillers so that power travels from one power application portion to an adjacent power application portion.

The power application portions may function to pass power through the heating layer so that heat is generated. The power application portions may be electrodes, buses, or both. The heater layer may be free of any additional electrically conducting layers (e.g., buses, electrodes, terminals, traces, spurs, braches, or a combination thereof). Preferably, the heater layer includes power application portions (e.g., buses, electrodes, or both) that extend substantially along a length and/or width of the heater layer and assist in applying power to the heater layer. More preferably, the heating layer is free of terminals that connect the power source to the heater (i.e., a single point of power application). The heating layer may be free of gold, silver, copper, or a combination thereof. The heater layer may include positive temperature coefficient material (PTC), may be made of a positive temperature coefficient material, or both. The heating layer may be free of any additional electrically conducting layers, positive temperature coefficient layers, additives, or a combination thereof that are added to the heating layer in a separate step, that assist in producing heat, or both, other than the conductive fillers.

The heating layer may be free of a stabilizing material, a flame retardant, antimony trioxide, a soft filling substance, an impregnated filling material, or a combination thereof. For example, the heating layer is free of a stabilizing material, a soft filing substance, an impregnated filling material, or a combination thereof that is added to the heater to assist in conducting power between the conductive fillers. More preferably, the heating layer may be the only portion of the heater required to produce heat. For example, the heating layer may not be a substrate, the heating layer may be free of one or more materials disposed and/or printed on to form the heating layer, a material interwoven into the material, or a combination thereof. The configuration of the heating layer may be used to vary a resistivity, surface power density, or both of the heating layer.

A heating layer as discussed herein has a resistivity and a surface power density. The resistivity and the surface power density of the heating layer may be varied by varying the material construction of the heating layer, varying the amount of conductive filler, varying the type of conductive filler, or a combination thereof. The resistivity of the heating layer may be about 1Ω or more, preferably about 2.5Ω or more, or more preferably about 4Ω or more. The resistivity of the heating lay may be about 20Ω or less, about 15Ω or less, about 10Ω or less, or preferably about 8Ω or less (i.e., from about 4Ω to about 8Ω). The resistivity may be directly proportional to the surface power density of the heating layer. Preferably, the resistivity is inversely proportional to the surface power density of the heating layer. Thus, as the resistivity is increased the surface power density is decreased.

The conductive fillers of the heating layer include a diameter. The average diameter of the conductive fillers may be about 0.001 microns or more, preferably about 0.005 microns or more, preferably about 0.01 microns or more, or most preferably about 0.05 microns or more. The average diameter of the conductive fillers may be about 100 microns or less, about 75 microns or less, or preferably about 50 microns or less. The diameter of the conductive fillers may be from about 50 microns to about 1 micron.

The material of the heating layer possess a thickness. The thickness of the heating layer may be any thickness so that upon application of power the heating layer produces heat. The resistivity of the heating layer may be directly proportional to the thickness of the heating layer, the amount of conductive fillers in the heating layer, or a combination of both. The heating layer may be sufficiently thin so that the resistivity is from about 2Ω to about 10Ω and preferably from about 4Ω to about 8Ω. The thickness of the heating layer may be about 0.001 mm or more, about 0.005 mm or more, or preferably about 0.07 mm or more. The thickness of the heating layer may be about 15 mm or less, about 10 mm or less, preferably about 5 mm or less, more preferably about 2 mm or less, or more preferably about 1.0 mm or less. The thickness of the heating layer may be between about 0.01 mm and about 5 mm, preferably between about 0.1 mm and about 3 mm, and more preferably between about 1 mm and about 2 mm.

The material of the heating layer may have resistance to chemicals. Generally, the material of the heating layer may exhibit one or more of the following resistances to chemicals and/or material characteristics. The material of the heating layer may have good resistance to strong acids. The material of the heating layer may have excellent resistance to weak acids. The material of the heating layer may have poor resistance to strong bases, The material of the heating layer may have good resistance to weak bases. The material of the heating layer may have excellent chemical resistance to organic solvents. The material of the heating layer may be non-abrasive, non-hardening, self-lubricating, or a combination thereof.

The heating layer may be formed by mixing together one or more of the compositions discussed herein. The mixed composition may be extruded forming a sheet, a mat, or both. The composition may be poured into a mold forming the heating layer. The heating may be formed by mixing together a plurality of conductive fillers and forming a mat and/or sheet. The materials may form a first substance that may exhibit heating characteristics discussed herein.

The heating layer may be attached to at least two power application portions and upon application of electricity (e.g., power) the heating layer produces heat. The heating layer when connected to a positive power source and a negative power source (i.e., power application portions) may produce heat. Preferably, the heating layer is free of terminals that connect to buses and/or power application portions to the heating layer. For example, the power application portions (e.g., buses and/or electrodes) may be connected to the heating layer and the power application portions may be connected to the power source. The power wires may directly and/or indirectly attach to the heating layer using any device so that electricity enters the heating layer through a termination point (e.g., terminal) and the heating layer produces heat.

The terminals may be crimped onto the heating layer, the power application portions, or both. For example, the power applications may include terminals that connect a power source to the power applications. The terminals may be connected by sewing, bonding, a mechanical fastener, or a combination thereof to the heating layer, each power application portion, or both. Preferably, the heating layer may free of terminals directly attached to the heating layer (i.e., a single point of power application). The heater may be free of mechanical fasters that attaches a power wire to the heater. For example, the heating layer may not have a mechanical attachment device that grips the heating layer and secures one or more wires to the heater. The heating layer may include two or more power application portions that assist in supplying power to the heating layer.

The two or more power application portions may be located at any location on the heater layer. Preferably, the two or more power application portions are spaced apart. The two or more power application portions may be spaced a sufficient distance apart so that the heater layer is partially and/or entirely energized upon an application of power. The one or more power application portions maybe spaced apart a distance of about 20 cm or more, about 25 cm or more, or about 30 cm or more. More preferably, the two or more power application portions are located in an edge region of the heater layer. For example, one power application portion may be located along one edge of the heater layer and a second power application portion may be located along the opposing edge so that as power travels from the first edge to the second edge heat is generated. When more than one power application portion is present, the power application portions may be parallel, converging, diverging, mirror images, divided by a centerline, follow the shape of the heating layer, extend around one or more through holes, or a combination thereof. Each power application portion may include one or more parts for applying power. In one preferred example, each of the power application portions consist of two discrete bus bars, electrodes, wires, or both that are connected together and each of the two bus bars, electrodes, wires, or a combination thereof and assist in supplying power to the heating layer. The buss bars, electrodes, wires, or a combination thereof may be made of the same material, different material, or a combination thereof.

Each of the power application portions, preferably, are made of two or more different materials. The power application portions may include one or more wires and preferably two or more wires that are interwoven together. The wires may be made of any conductive material that assists in transferring power to the heating layer so that heat is produced. Each wire may have a resistivity of about 5 Ω*m or less, about 2 Ω*m or less, or about 1 Ω*m or less. Each wire may have a resistivity of about 0.01 Ω*m or more, about 0.05 Ω*m or more, or about 0.01 Ω*m or more (i.e., about 0.25 Ω*m). Each of the wires in a preferred embodiment is a composite of a plurality of wires braded together to form a single wire. For example, the wire may be 20 silver wires each having a diameter of about 0.07 mm, and each of the 20 silver wires may be braided together to form a single wire. The wires are preferably made of copper, silver, gold, nickel, or a combination thereof and/or coated with copper, silver, gold, nickel, or a combination thereof so that power is transferred to the heating layer. The one or more wires may be connected to the heating layer by any device that fixedly connects the one or more wires to the heater and does not substantially interfere with the transfer of power to the heating layer. Some examples of attachment devices and/or methods that may be used are sewing, gluing (e.g., with conductive or non-conductive glue), bonding, interweaving, stapling, or a combination thereof. Preferably, an adhesive layer is used to connect the one or more wires of the power application portions to the heating layer.

The power application portions may be made of any material that upon application of power assists in transferring the power to the heating layer so that the heating layer becomes hot. The power application portions may include a bus bar and/or electrode that is located under the one or more wires, preferably over the one or more wires, or a combination of both. The power application may be free of a wire and may only be made of a nonwoven material as discussed herein. The power application portions may be a nonwoven material that has electrically conductive properties. The power application portions may be one or more conductive non-woven strips. The power application portions may be made of the same material as the heating layer. Preferably, power application portions may be made of a carbon material, a polymeric material, a metallic coated material, or a combination of materials that form a conductive medium for carrying power to the heater. For example, the power application portions may be a plurality of nylon conductive fillers that are coated with nickel or silver and the coated nylon conductive fillers may be are bonded together in a binder and form a nonwoven material that conducts power to the heating layer. The power application portions may be attached to the heating layer using any material and/or method as discussed herein for the one or more wires. Preferably, the power application portions are connected to the heating layer using an adhesive fabric. More preferably, each power application portion includes two or more wires and a non-woven conductive material that are connected to the heating layer by an adhesive layer.

The adhesive layer may be any adhesive sheet that forms a connection upon an application of heat. The adhesive layer may be a polyamide. The adhesive layer preferably may be a non-woven material. The adhesive layer preferably may be a plurality of conductive fillers and/or conductive filler-like adhesive particles interconnected with voids and/or pores between the interconnected conductive fillers and/or conductive filler-like adhesive particles. The adhesive layer may have a plurality of voids, a plurality of pores, or both. The adhesive layer may have a sufficient amount of voids and/or pores so that when the adhesive is connecting two or more electrically conducting layers (e.g., one or more layers of the power application, the heating layer, or both) power may pass through the voids and/or pores, an electrical connection may be maintained, the adhesive layer does not interfere with the supply of power between two or more electrically conducting layers, or a combination thereof, and a connection may be formed between the two or more layers. The voids and/or pores of the adhesive layer may represent an area of about 10 percent or more, about 20 percent or more, about 30 percent or more, preferably about 40 percent or more, or more preferably about 45 percent or more of a total surface area of the heating layer. The voids and/or pores of the adhesive layer may represent an area of about 90 percent or less, about 80 percent or less, about 70 percent or less, or about 60 percent or less of the total surface area of the heating layer. The adhesive may have an initial melting temperature of about 85° C. or more, about 100° C. or more, or about 110° C. or more, The adhesive may have an initial melting temperature of about 200° C. or less, about 180° C. or less, or about 160° C. or less (i.e., about 150° C.). An example of an adhesive fabric that may be used is sold under the trade name Spunfab available from Spunfab Ltd.

The heater may be comprised of only a heating layer (e.g., the heater may include one layer). Preferably, the heater includes at least three layers. However, the heater may be free of any layers that are secured over the heating layer. For example, the heater may be free of a protective layer or a covering layer extending over the heating layer. Preferably, the heater includes an forward cover layer, an rearward cover layer, or both. The one or more cover layers may be a protecting layer. The forward cover layer, the rearward cover layer, or both may be made of the same material, a different material, or both. The forward cover layer, the rearward cover layer, or both may be made of any material that protects that heater and exhibits one or more of the characteristics listed herein. The forward cover layer, the rearward cover layer, or both may be made of a polymeric material, a woven material, a nonwoven material, or a combination thereof. The forward cover layer, the rearward cover layer, or both may substantially encapsulate the heater layer, form a hermetic seal around the heating layer, or both. The heating layer may be sandwiched between the forward cover layer and the rearward cover layer, but a hermetic seal may not be formed. The forward cover layer and the rearward layer may have a sealed peripheral edge. The forward layer, the rearward layer, or both may form a fluid impenetrable barrier layer. The forward cover layer, the rearward cover layer, or both may be moisture resistant; may be flexed, bent, folded, crimped, or a combination thereof repeatedly without plastically deforming, elastically deforming, failing, breaking, tearing, creasing, or a combination thereof; heat resistant; flame resistant; chemical resistant; or a combination thereof. The forward cover layer, the rearward cover layer, or both may be a film. The forward cover layer, the rearward cover layer, or both may be made of or include a polymeric material that glued and/or surface melted (i.e., heat laminated to the heating layer). The polymeric material may be a polyester, polyurethane, polyethylene terephthalate; polyvinyl fluoride, polyethylene, polyetherimide, acrylic adhesive, acrylic, urethane, silicone, rubber (e.g., natural, synthetic, acrylic, butadiene, butyl, chlorobutyl, chlorinated polyethylene, chlorosulphonated polyethylene, ethylene propylene rubber, or a mixture thereof); or a combination thereof. The material of the forward cover layer, the rearward cover layer, or both may have glass transition that is sufficiently high so that the forward cover layer, the rearward cover layer, or both are free of softening in the temperature range of the heating layer. The forward cover layer, the rearward cover layer, or both may have a glass transition temperature of about 105° C. or more, preferably about 115° C. or more, and more preferably about 120° C. or more. The forward cover layer, the rearward cover layer, or both may include one or more pockets.

The one or more pockets may function to receive one or more components of the heater and protect the one or more components from environmental conditions. The one or more pockets may be a portion of a cover layer, protective layer, or both that is free of connection with the heater layer, free of adhesive, has at least one edge that is not sealed about the heater layer, is free of a fixed connection with the heating layer, or a combination thereof so that materials may be added or subtracted from the pocket during the manufacturing process. The one or more pockets may receive one or more sensors, one or more power wires, one or more measuring wires, or a combination thereof. The one or more pockets may create a fluid impermeable barrier, may seal the heating layer and associated wires and/or sensors within the cover layer, the protective layer, or both. The one or more pockets may form a seal so that the heater when completed is substantially impermeable to fluid penetration, the heater is waterproof, or both. The one or more pockets may protect the connections without the need for additional devices to prevent fluid penetration, current leakage, or both. The one or more pockets may be sealed after components are placed in the pocket, may be the final step in forming a heater, may be sealed to the heater layer, sealed to another protective layer, or a combination thereof. The one or more pockets may be used instead of using shrink tubes to form a fluid resistant connection. The one or more pockets may be used with shrink tubes. The one or more shrink tubes may function to connect together two or more wires and form a water resistant, water proof, or both connection between two or more wires. The one or more shrink tubes may include a material that once heated liquefies and then solidifies sealing the wires within the shrink tube so that liquid is prevented from penetrating into the shrink tube. Additional teachings of the shrink tubes taught herein are found in U.S. patent application Ser. No. 14/265,610, filed on Apr. 30, 2014 the teachings of which are incorporated herein in their entirety for all purposes. Specifically, the teachings of paragraphs 0023-0037 are incorporated by reference herein for all purposes with regard to the wires and shrink tubes that may be used with the present teachings. The one or more pockets are preferably part of a cover layer and/or protective layer and are a separate layer from the heating layer.

The heating layer may incorporate partially and/or entirely a discrete material (i.e., a protecting layer) into the heating layer so that the heating layer is protected by the protecting layer. The protecting layer may be a reinforcing layer. Preferably, the protecting layer increases the strength of the heating layer and forms a partially dielectric coating over the heater or a fully dielectric coating over the heater. The protecting layer may form an insulating layer over the forward surface, the rearward surface, the side edges, or a combination thereof of the heating layer so that the heating layer on the outside has dielectric characteristics. The protecting layer may be made of any material as discussed herein for the forward cover layer, the rearward cover layer, or both. The protecting layer may be applied to a heating layer before the power applications are connected to the heating layer, after the power applications are applied, or a time therebetween. For example, if a completely dielectric heater is desired then the power applications are applied to the heating layer and then the protecting layer is applied over both the heating layer and the power application layers. The material properties of the protecting layer may affect the final characteristics of the heater (e.g., conductivity of the heater, strength, the like, or a combination thereof).

The heater may include one or more attachment layers. The attachment layer may be a single sided or two sided adhesive layer. The entire attachment layer may be made of adhesive. The attachment layer may be made of the same material as the adhesive discussed herein for attaching the power applications. The attachment layer may be an adhesive layer (e.g., a glue, paste, spray on adhesive, an adhesive film, a peel and stick, hook and loop, or the like). Preferably, the attachment layer may be a peel and stick film. The attachment layer may exhibit protection characteristics as discussed herein. The heater may be free of an attachment layer.

The heater (e.g., heating layer, forward cover layer, rearward cover layer, adhesive layers, attachment layers, or a combination thereof) as discussed herein may have a high fold resistance. The heater may have sufficient fold resistance so that the heater when placed in a seat may withstand wear for about 5 years or more, preferably about 7 years or more, or more preferably use for 10 years or more. The heater may have sufficient fold resistance that the heater may withstand 50,000 cycles or more, preferably 100,000 cycles or more, or more preferably about 200,000 cycles or more in the Z-direction without the heater losing any function.

The heater as discussed herein is produced using a process. The process may include one or more of the following steps produced in virtually any order. A plurality of the conductive fillers discussed herein may be obtained. The conductive fillers as discussed herein may be coated with metal, chopped to a desired length, refined so that the conductive fillers are flatted, refined so that the conductive fillers have an oval shape, or a combination thereof. The conductive fillers may be mixed with, covered, with, moved into contact with, or a combination thereof any thermoplastic elastomer as discussed herein. Preferably, the conductive fillers are mixed within a polymer (e.g., thermoplastic elastomer) while the polymer is in a fluid form. The conductive fillers may be mixed within a polymer forming a homogeneous mixture. The conductive fillers may be mixed into the polymer before being placed into a forming machine, within a forming machine, as a shape is being formed, or a combination thereof. The conductive fillers may be arranged within a formed product (e.g., a heater layer) so that the conductive fillers have a random orientation. The heating layer may be extruded with or without conductive fillers in the polymer forming a nonwoven sheet. Attaching the heating layer and the one or more wires, one or more non-woven conductive strips, one or more electrodes and/or bus bars, attaching one or more pre-assembled power application portions, or a combination thereof so that an electrical connection is formed to the heating layer. Producing a pre-assembled power application portion by combining one or more wires, one or more non-woven conductive strips, one or more adhesive layers, one or more bus bars and/or electrodes, or a combination thereof together so that when placed on the heater layer and heated the adhesive connects the pre-assembled power application to the heating layer and an electrical connection is formed. Connecting the one or more power applications to a power source, a wire, or both. Applying a shrink tube to the one or more power applications, power sources, power wires, measuring wires, or a combination thereof. Heating the one or more shrink tubes so that the shrink tube shrinks and the one or more power applications and power sources, power wires, measuring wires, or a combination thereof are electrically and physical connected. Placing the one or more power wires, measuring wires, or both within pockets in the protective layer. Placing one or more sensors within the pocket. Sealing the pockets of the protective layer. Applying a forward cover layer, a rearward cover layer, a connection layer (e.g., adhesive layer, mechanical attachment layer, or both), or a combination thereof to the heating layer. Cutting the heating layer so that the heating layer includes a desired length, a desired width, slits, through holes, cutouts, or a combination thereof. Applying a fire retardant material, a flame resistant material, a water resistant material, a dielectric layer, or a combination thereof to the heating layer. Attaching a temperature sensor to the heating layer, the heater, or both. Electrically connecting the temperature sensor to a power source. Connecting (e.g., physically and/or electrically) the heating layer to a controller, a control module, or both. Connecting the heater to an article of manufacture. Connecting the heater to an occupant contact location. Connecting the heater to a vehicle seat, a floor, a steering wheel, a mirror, an insert, or a combination thereof.

The process may create a heating layer using one or more devices. The one or more devices may be an extruder, a rolling mill, a press, liquid pouring, compression molding, or a combination thereof. The process may include one or more rolls that include completed heater components (e.g., power application rollers and/or protective layer rollers). For example, a completed power application portion may be on a roll and the completed power application portion may be unrolled while being applied to a heating layer. The process may include one or more application rollers (e.g., pressure and/or heated rollers) that may assist in connecting two or more layers. The one or more application rollers may heat adhesive so that it melts and forms a connection with a heating layer. The one or more application rollers may assist in supporting (e.g., be a support roller) the heating layer, the power application layers, or both during formation of the heater. As each of the steps is performed the layer may be wound up on a receiving roller. For example, a completed heater may be placed on a receiving roller, the heating layer including the power application portions may be wound on a receiving roller before the protective layers are added, or both. The heating layer before or after power application portions, protective layers, other components, or a combination thereof are added may be cut to a predetermined size and shape. The heating layer may be cut and then wires added so that a heater is formed.

The heater a discussed herein may be controlled using any method discussed herein. The heater may include one or more sensors that assist in controlling the temperature of the heater. The heater may include positive temperature characteristics and thus, may be self-regulating, however, one or more sensors may control the temperature of the heater. The one or more sensors may be a single thermistor. The sensor may control heating, cooling, ventilation, fan speed, or a combination thereof. Preferably, the heater includes a thermistor or a negative coefficient temperature sensor that measures the temperature of the heater and based upon the measured temperature a controller controls the temperature of the heater, the ventilation system, the conditioning system, or both. The sensor may be connected to one or more measuring wires. Preferably, the sensor is connected to at least two measuring wires. The sensor may be connected to three measuring wires or even four measuring wires. The sensor may be connected to two measuring wires and a common ground. The sensor may be grounded to the heater layer. The sensor may be located at virtually any location on the heating layer, on the heating layer face, on a side of the heater facing an occupant, or a combination thereof. Preferably, the sensor is located in a central location on the heater layer. The heater, the conditioning system, the ventilation system, or a combination thereof may be controlled using pulse width modulation.

FIG. 1 illustrates a heater 2 being formed by an extruder 30 and the power application portions 6 being applied to the heater layer 4 as the heater layer travels in the machine direction 100 from the extruder 30. As illustrated, pre-formed power application portions 6 are transported from the power application rollers 42 through a nip between a heated and/or pressurized roller 46 and a support roller 48 in the machine direction 100 an unto a receiving roller 60 that winds up the combined heater layer 4 and power application portions 6.

FIG. 2 illustrates a heater layer 4 being transported from a heater roller 40 while the power application portions 6 are transported in the machine direction 100 from the power application rollers 42. The power application portions 6 and the heater layer 4 are fed though a nip between a pressure and/or heated roller 46 and a support roller 48 where the heater layer 4 and power application portions 6 are connected. The connected heater layer 4 and power application portions 6 are then wound up on a receiving roll 60.

FIG. 3 illustrates a heater layer 4 with connected power application portions 6 being unrolled from a heater roller 40. The layer travels from the heater roller 40 in the machine direction 100 where a protective layer 10 is applied to each side of the heater layer 4 from a pair of protective layer rollers 44. The layer (including the heater layer 4 and power application portions 6) and the protective layers 10 are then fed through a nip between two pressure and/or heated rollers 46 so that a heater 2 is formed. As illustrated, the protective layer 10 on the upper side includes pockets 12 that do not connect to the heater layer 4 or the power application portions 6 during this stage.

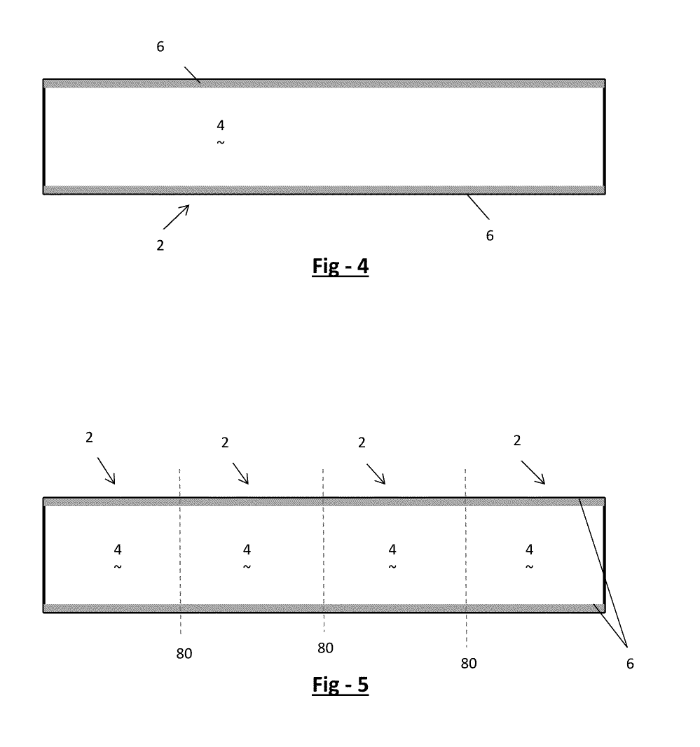

FIG. 4 illustrates a heater 2 laid out so that the heater layer 4 and the pair of power application portions 6 in opposing edge regions are shown.

FIG. 5 illustrates the heater 2 of FIG. 4 sectioned along lines 80 to form a multitude of individual heaters 2 that each include a heating layer 4 and power application portions 6.

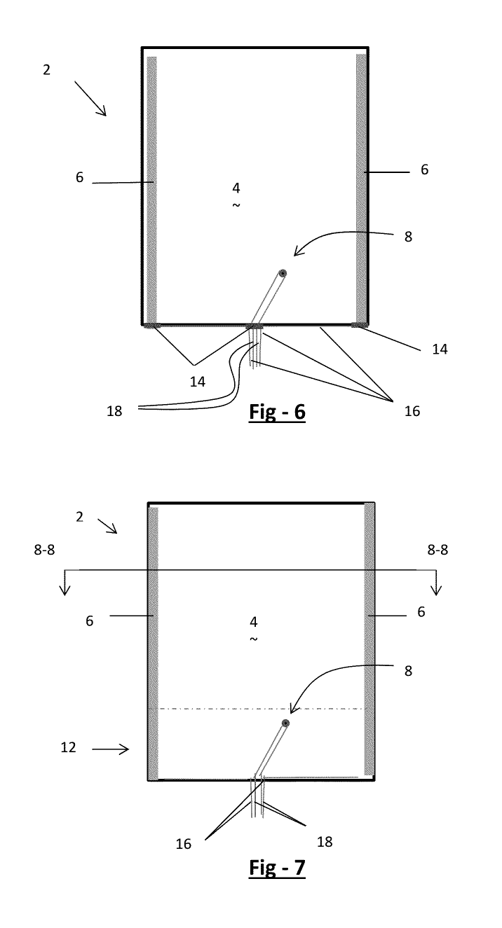

FIG. 6 illustrates a top view of a heater 2 having power application portions 6 along the edge regions of the heater layer 4 and power wires 16 physically connected to the heater layer 4. The measuring wires 18 are electrically connected to a sensor 8 by one or more shrink tubes and the power wires 16 are electrically connected to each of the power application portions 6 by shrink tubes 14. As illustrated, the entire heater is substantially impervious to fluid penetration.

FIG. 7 illustrates a heater 2 including power application portions 6 along the edge regions of the heater layer 4. The heater 2 includes a plurality of power wires 16 connected to the heater 2. The measuring wires 18 are connected to a sensor 8 (the heater may include more than one sensor) and the power application portions 6 at connection points so that power and/or sensing signals are transmitted to and from the heater 2. The sensor 8 and measuring wires 18 are located within a pocket 12 that covers the measuring wires 18 and connection points so that the power wires 16 and connection points are substantially impervious to fluid penetration without the use of shrink tubes. As illustrated, the entire heater is substantially impervious to fluid penetration.

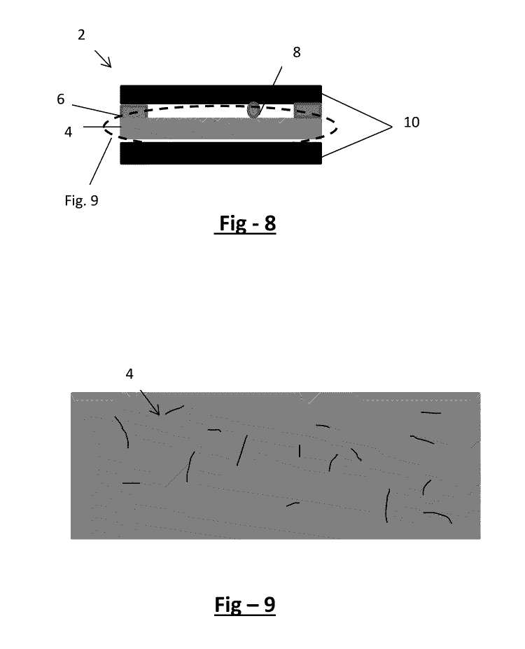

FIG. 8 illustrates a cross-sectional view of the heater 2 of FIG. 7 cut along lines 8-8. The heater 2 includes a heater layer 4 with a pair of power application portions 6 with a sensor 8 located in a central region of the heater 2. The heater 2 includes a protective layer 10 on each side of the heater layer 4 and extending over the power application portions 6 and sensor 8.

FIG. 9 illustrates a close up view of the heater layer of FIG. 8. As illustrated, the heater layer 4 is comprised of a polymeric material 90 with a plurality of randomly disposed fibers 92. The fibers 92 increase the conductivity of the heater layer 4 so that power can travel through the heater layer 4 generating heat.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

We claim:

1) A heater comprising:
a heater layer including:
a) a thermoplastic elastomer; and
b) a plurality of conductive fillers mixed within the thermoplastic elastomer,
wherein the conductive fillers are a metal coated material or entirely made of metal; and
wherein the heater layer is made up of about 30 percent or less conductive fillers.

2) The heater of claim 1, wherein the heater layer has self-regulating characteristics.

3) The heater of claim 1, wherein the conductive fillers have an average length of about 3 mm or less.

4) The heater of any of claim 1, wherein the conductive fillers are carbon fibers coated with zinc, carbon fibers coated with nickel, graphite fibers coated with nickel, nickel nanostrands, a pure metal fiber, or a combination thereof.

5) The heater of claim 1, wherein the thermoplastic elastomer has a linear thermal expansion coefficient of about 100×10⁻⁶/K or more.

6) The heater of any claim 1, wherein the thermoplastic elastomer has a linear thermal expansion coefficient of about 300 ×10⁻⁶/K or less.

7) The heater of claim 2, wherein the thermoplastic elastomer is polyethylene, polypropylene, ethyl vinyl alcohol, thermoplastic urethane, nylon 6, nylon 6-6, nylon 12, polyimide, or a combination thereof.

8) The heater of claim 1, wherein the heater layer has a resistivity from about 4 Ohm-square to about 8 Ohm-square.

9) The heater of claim 1, wherein the heater layer has a thickness of about 2 mm or less.

10) The heater of claim 1, wherein the heater layer has a coefficient of thermal expansion of about 0.8 or more when measured at 65° C.

11) The heater of claim 1, wherein the heater layer includes one or more power application portions that are a copper mesh that is coated with silver or a nylon base coated with nickel.

12) The heater of claim 1, wherein the heater layer includes a front side and a rear side and the front side, the rear side, or both are covered with a protective layer.

13) The heater of claim 12, wherein the protective layer is a fleece material.

14) The heater of claim 12, wherein the protective layer includes one or more pockets that cover and enclose one or more connections so that the connections are substantially protected from fluid penetration, current leakage, or both.

15) The heater of any of claims 10, wherein the one or more power application portions are connected to one or more power wires via a connector and the connector is a shrink tube that forms a protective layer which is substantially impervious to fluid penetration, current leakage, or both.

16) The heater of claim 11, wherein the one or more power application portions are located a distance apart of about 15 cm or more.

17) A method of producing a heater comprising:
a. mixing a thermoplastic elastomer together with a plurality of conductive fibers;
b. forming the mixture into a sheet;
c. cutting the sheet into one or more heating layers;
wherein upon application of power the heating layer provides heat,
wherein the conductive fillers are a metal coated material or entirely made of metal; and
wherein the heater layer is made up of about 30 percent or less conductive fillers.

18) The method of claim 17, wherein the method includes a step of applying one or more power application portions to the sheet, the heater layer, or both.

19) The method of claim 17, wherein the method includes a step of applying a protective layer to one or both sides of the heater layer.

20) The method of claim 17, wherein the protective layer on one or both sides includes a pocket and one or more power wires extend into the pocket and connect to the one or more power application portions, and once the connection is formed the pocket is sealed forming a substantially fluid impermeable barrier, preventing current leakage, or both.
